(19) United States
(12) Patent Application Publication
(10) Pub. No.: US 2002/0046120 A1
(43) Pub. Date: Apr. 18, 2002

(54) Method of obtaining personal and survey information through games of chance

(76) Inventors: Matthew G. Collins, Mukwonago, WI (US); Timotthy G. Collins, Sherewood, WI (US)

Correspondence Address: Donald J. Ersler, 725 Garvens Avenue, Brookfield, WI, 53005, US

(21) Appl. No.: 09/975,212

(22) Filed: Oct. 11, 2001

Related U.S. Application Data
(60) Provisional application No. 60/241,066, filed on Oct. 16, 2000.
(60) Provisional application No. 60/277,249, filed on Mar. 20, 2001.

(51) Int. Cl. G06F 17/60

(52) U.S. Cl. 705/14

(57) ABSTRACT

A method of obtaining personal and survey information includes at least one information entry processor, off site central server, and mail fulfillment house. The information entry processor includes a touch screen user interface, central processing unit, and entry modem. Entry of personal information may be made through a keyboard displayed on the touch screen or a card swipe reader. A prospect enters personal and survey in exchange for a chance to win some type of prize by playing a game contained on the information entry processor. The information entry processor will send the information entered to the off site central server. The mail fulfillment house will use the personal contact and survey answers to mail follow-up letters to prospects. In a second embodiment, the at least one information entry processor is replaced with a web page. Database management software allows personal information records to be manipulated in numerous ways for both embodiments. At least three security levels allow only qualified individuals to access and manipulate personal information records.

### CROSS-REFERENCE TO RELATED APPLICATIONS

This is a utility application, having priority from provisional patent applications, Ser. No. 60/241,066 filed on Oct. 16, 2000 and 60/277,249 filed on Mar. 20, 2001.

### BACKGROUND OF THE INVENTION

1. Field of the Invention

The present invention relates generally to obtaining information from potential customers or prospects and more specifically to a method of obtaining personal and survey information through games of chance.

2. Discussion of the Prior Art

Currently, obtaining qualified prospect leads, administering customizable surveys, or conducting automated follow-ups can be difficult and expensive. For example, a prospect who visits a car dealership. The number one priority of any sales team is to close the deal, but only a small fraction of the prospects that visit the dealership actually purchase a vehicle. Since a salesperson is unable to follow-up with a prospect for whom no personal contact information (name, phone number, address) is known, it follows that a major amount of effort is spent trying to obtain that information. Several methods of obtaining personal information are presently being employed such as fishbowls, cold calling, “man in the red hat,” and computer based manual entry methods. These and many other methods are usually ineffective and unreliable. Another priority of an auto dealership may be to conduct prospect customizable audits and surveys to measure prospect preferences or media effectiveness. Another desire of the dealership may be to conduct automated follow-up to ensure that all prospects are processed.

Accordingly, there is a clearly felt need in the art for a method of obtaining personal and survey information through games of chance which provides an incentive for prospects to enter personal information about themselves and also to answer surveys.

### SUMMARY OF THE INVENTION

The present invention is a method of obtaining personal and survey information through games of chance by providing an incentive to the prospect to participate in providing personal information and answer survey questions. The method of obtaining personal and survey information includes at least one information entry processor, off-site central server, and mail fulfillment house. The information entry processor preferably includes a touch screen user interface, central processing unit, and entry modem. Entry of personal information & survey responses may be made through a keyboard displayed on the touch screen or a card swipe reader.

A prospect enters personal contact information and answers to survey questions in exchange for a chance to win some type of prize by playing a game contained on the information entry processor. If a prospect wins a prize, the prospect will receive a prize voucher (with prize redemption instructions) after playing the game. The information entry processor will convert the personal contact information and survey responses into an electronic file and the contact file will be sent to the off site central server through the entry modem. The off-site central server will periodically send a plurality of contact files to a mail fulfillment house at merchant-defined intervals. The mail fulfillment house will send letters to the prospect contained within the contact files. The terms “merchant” and “company” are used interchangeably in this disclosure.

In a second embodiment, the at least one information entry processor is replaced with a web page. Entry of personal and survey information is done through the computer keyboard or equivalent. The prospect's computer is linked to the central server through the internet. The off site central server will convert the prospect contact information and survey responses into an electronic file. The off-site central server will periodically send a plurality of contact files to the mail fulfillment house. The mail fulfillment house will mail merge, assemble, and send letters to prospects contained within the contact files.

Database management software allows records to be manipulated in numerous ways for both embodiments. The origin of the personal information is provided. Sales status of the records is given at time of origin. Filtering by different parameters is possible. Further filtering by answers to survey questions is also possible. At least three security levels allow only qualified individuals to access specified features and differing levels of access to prospect records.

Accordingly, it is an object of the present invention to provide a method of obtaining personal information through offering some type of prize.

It is a further object of the present invention to provide a method of obtaining survey answers through playing a game of chance.

It is yet a further object of the present invention to provide database management software functionality which allows searching by a single parameter.

It is yet a further object of the present invention to provide database management software functionality which allows searching by multiple parameters.

It is yet a further object of the present invention to provide database management software which provides several levels of security.

It is yet a further object of the present invention to provide a method of obtaining personal information which does not require a salesperson to extract personal contact information from a prospect.

Finally, it is an another object of the present invention to provide a method of obtaining answers to customizable survey questions which does not require a salesperson to administer the survey.

These and additional objects, advantages, features and benefits of the present invention will become apparent from the following specification.

### BRIEF DESCRIPTION OF THE DRAWINGS

FIG. 1 is a schematic diagram of a method of obtaining personal and survey information in accordance with the present invention.

FIG. 1a is a schematic diagram of a second embodiment of a method of obtaining personal and survey information in accordance with the present invention.

FIG. 2 is a schematic diagram of an information entry processor in accordance with the present invention.

FIG. 3 is a front view of a computer generated slot machine displayed on a touch screen in accordance with the present invention.

FIG. 3a is a flow chart of the software used for implementing the computer generated slot machine in accordance with the present invention.

FIG. 3b is a front view of a computer screen with a single frame from a flash movie used as a second example of a preferable game of chance in accordance with the present invention.

FIG. 4 is a front view of an import records screen of a database management software program contained on a central server in accordance with the present invention.

FIG. 5 is a front view of a view-edit-delete screen of a database management software program contained on a central server in accordance with the present invention.

FIG. 5a is a front view of a view-edit-delete screen of a database management software program after a locate record button has been depressed in accordance with the present invention.

FIG. 5b is a front view of an edit screen of a database management software program after an edit link is clicked on in accordance with the present invention.

FIG. 6 is a front view of a new record screen of a database management software program contained on a central server in accordance with the present invention.

FIG. 7 is a top front view of a table rank field screen of a database management software program contained on a central server in accordance with the present invention.

FIG. 7a is a bottom front view of a table rank field screen of a database management software program contained on a central server in accordance with the present invention.

FIG. 7b is a front view of a user field preference screen of a database management software program contained on a central server in accordance with the present invention.

FIG. 8 is a front view of an unassigned registrant screen of a database management software program contained on a central server in accordance with the present invention.

FIG. 9 is a front view of a review conversion screen of a database management software program contained on a central server in accordance with the present invention.

FIG. 10 is a front view of an aged records screen of a database management software program contained on a central server in accordance with the present invention.

FIG. 11 is a front view of an user preference screen of a database management software program contained on a central server in accordance with the present invention.

FIG. 12 is a front view of a deletion candidate screen of a database management software program contained on a central server in accordance with the present invention.

FIG. 13 is a front view of an orphaned records screen of a database management software program contained on a central server in accordance with the present invention.

FIG. 14 is a front view of a representative screen of a database management software program contained on a central server in accordance with the present invention.

FIG. 15 is a front view of an add rep screen of a database management software program contained on a central server in accordance with the present invention.

FIG. 16 is a top front view of a search screen of a database management software program contained on a central server in accordance with the present invention.

FIG. 16a is a bottom front view of a search screen of a database management software program contained on a central server in accordance with the present invention.

FIG. 17 is a top front view of a question screen of a database management software program contained on a central server in accordance with the present invention.

FIG. 17a is a bottom front view of a question screen of a database management software program contained on a central server in accordance with the present invention.

FIG. 17b is a front view of an add question screen of a database management software program after an add New Question link is clicked in accordance with the present invention.

FIG. 17c is a front view of an edit question screen of a database management software program after an edit link is clicked in accordance with the present invention.

FIG. 17d is a front view of a delete question screen of a database management software program after a delete link is clicked in accordance with the present invention.

FIG. 18 is a top front view of a prize settings screen of a database management software program contained on a central server in accordance with the present invention.

FIG. 18a is a bottom front view of a prize settings screen of a database management software program contained on a central server in accordance with the present invention.

FIG. 18b is a front view of an add prize screen of a database management software program after add powerguestbook prize link has been clicked in accordance with the present invention.

FIG. 18c is a front view of an icons screen of a database management software program after a view icons link has been clicked in accordance with the present invention.

FIG. 18d is a front view of an update prize screen of a database management software program after an edit link has been clicked in accordance with the present invention.

FIG. 19 is a front view of a mail settings screen of a database management software program for a first embodiment in accordance with the present invention.

FIG. 20 is a front view of a mail settings screen of a database management software program for a second embodiment in accordance with the present invention.

FIG. 21 is a front view of a master list status screen of a database management software program contained on a central server in accordance with the present invention.

FIG. 22 is a front view of a print screen of a database management software program contained on a central server in accordance with the present invention.

FIG. 23 is a first page of a relational flow chart of the features contained within the database management software program in accordance with the present invention.

FIG. 24 is a second page of a relational flow chart of the features contained within the database management software program in accordance with the present invention.

### DETAILED DESCRIPTION OF THE PREFERRED EMBODIMENTS

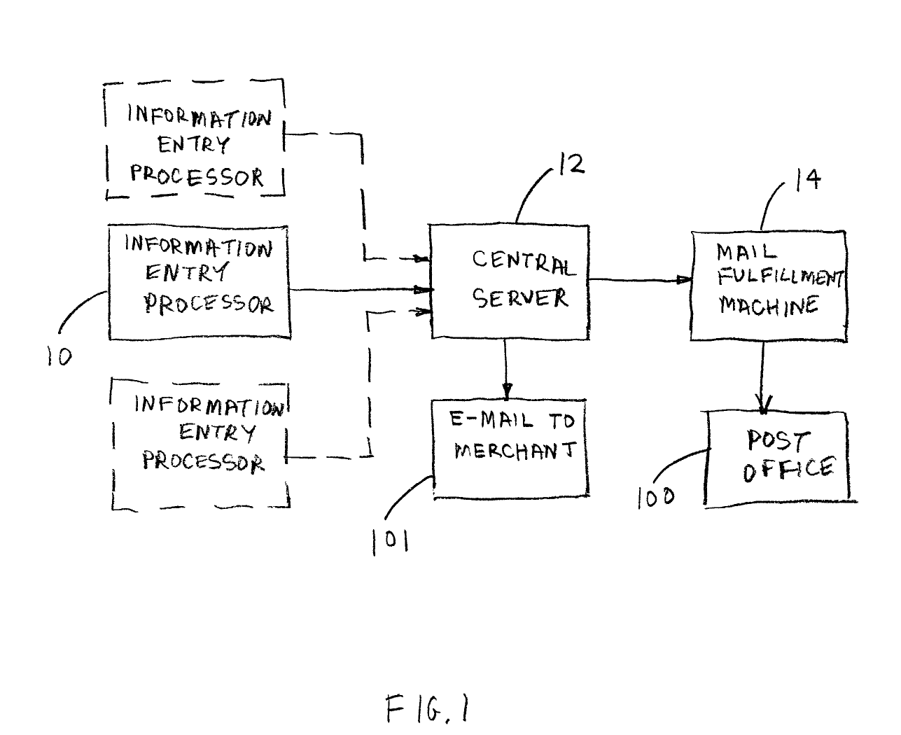

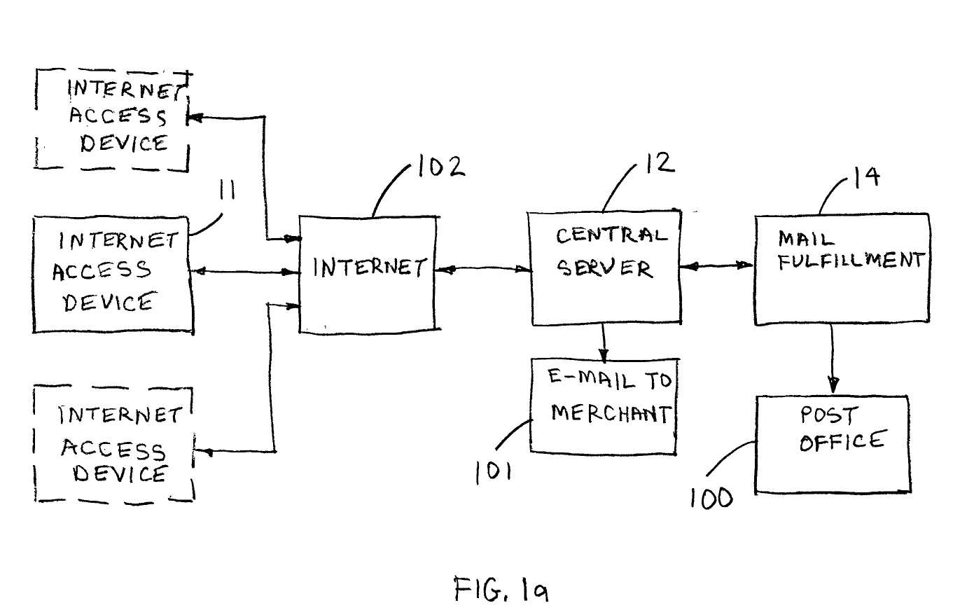

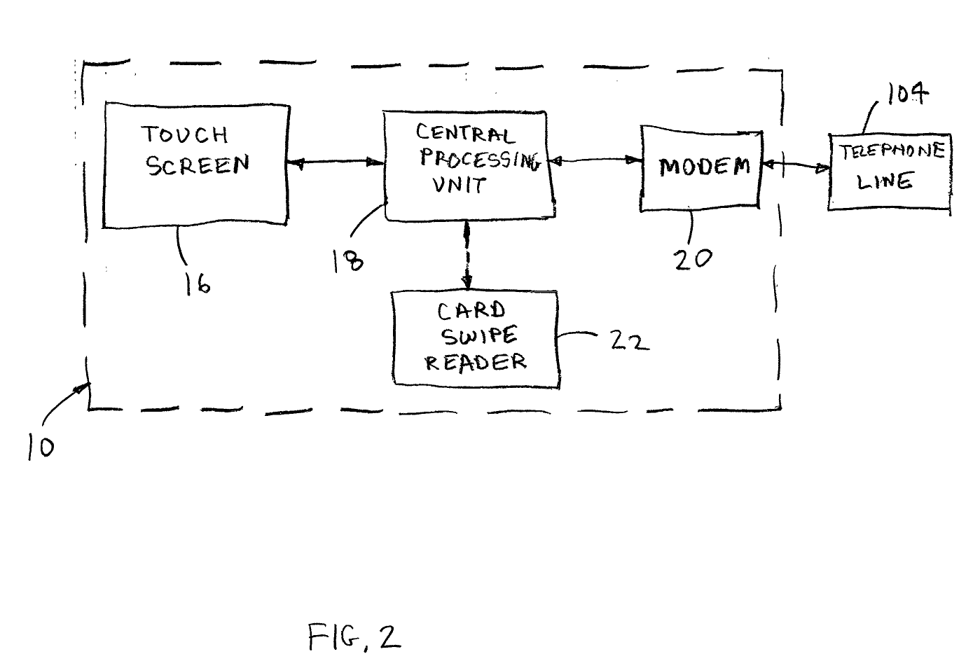

With reference now to the drawings, and particularly to FIG. 1, there is shown a schematic diagram of a method of obtaining personal and survey information 1. With reference to FIG. 2, the method of obtaining personal and survey information 1 includes at least one information entry processor 10, off-site central server 12, and mail fulfillment house 14. With reference to FIG. 2, the information entry processor 10 includes a touch screen user interface 16, central processing unit 18, and entry modem 20. Entry of personal contact information may be made through a keyboard displayed on the touch screen 16 or a card swipe reader 22. Entry of survey information is made through the keyboard displayed on the touch screen 16.

A prospect discloses personal contact information and answers survey questions in exchange for a chance to win some type of prize by playing a game contained on the information entry processor 10. The information entry processor 10 will convert the personal contact information and answers to survey information into an electronic file. The plurality of contact files are preferably sent to the off-site central server through the entry modem 20 and a telephone line 104 at merchant defined intervals.

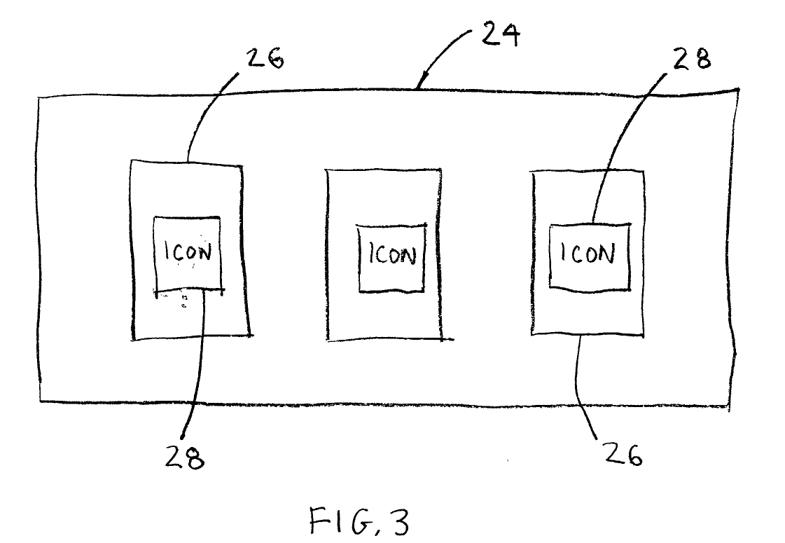

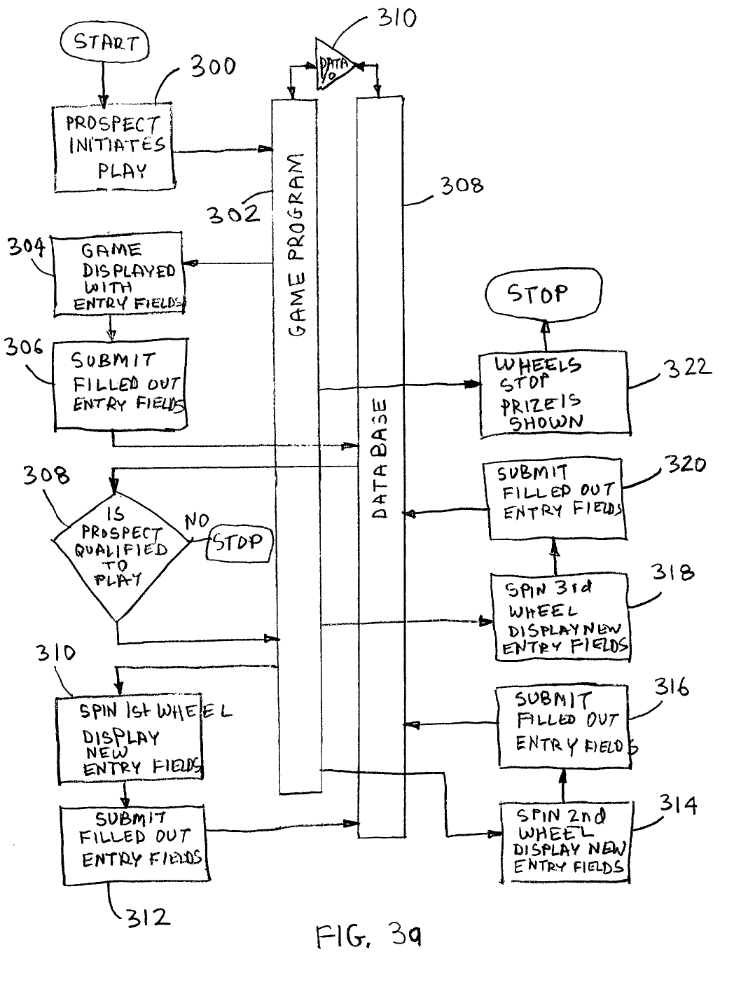

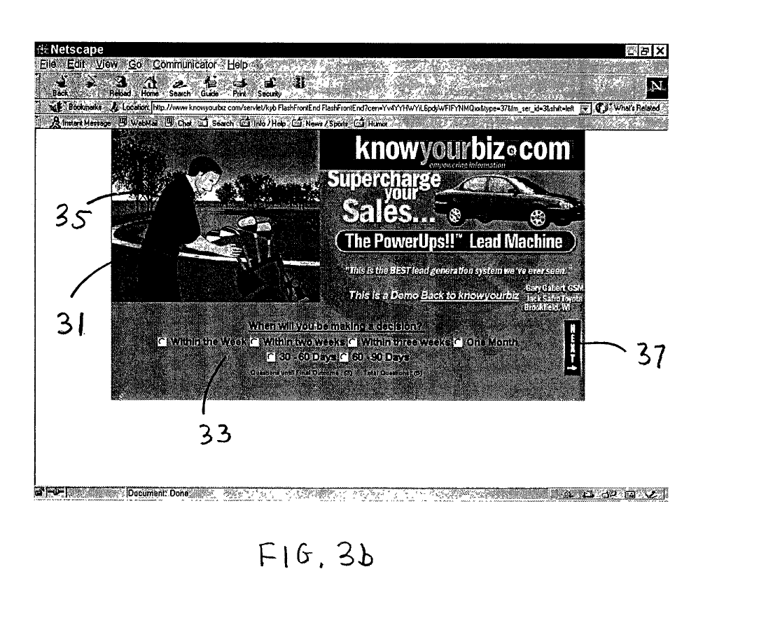

With reference to FIG. 3, the preferable game of chance is a computer generated slot machine 24 which is contained within the information entry processor 10. Other games of chance may also be used. The computer generated slot machine 24 has three rotating wheels 26 with at least four different icons 28 thereupon. A prize is associated with a combination of icons 28 displayed on the three wheels 26. A prospect has the possibility of winning several different prizes based on the combination of icons 28. Generally, the more valuable the prize, the lesser the odds of winning the prize.

The slot machine preferably operates according to the flow disclosed FIG. 3a. The prospect initiates play by pressing a return button, click on a start button, or by activating any other suitable device in process block 300. The game program 302 displays a plurality of entry fields such as first name, last name, address, city, state, postal code, social security number, phone number, and country in process block 304. Other merchant defined information may also be requested. The prospect enters previously mentioned information in process block 306 which is sent to the database 308. An I/O data link 310 exists between the game program 302 and the database 308. The database 308 inquires whether the prospect is qualified to play in decision block 308. If the prospect is not qualified to play the program stops.

If the prospect is qualified to play the game program 302 is contacted and the game program 302 displays a first spinning wheel and a first set of new entry fields in process block 310. The prospect fills out and submits the first set of new entry fields to the database 308 in process block 312. The database 308 stores the information in the first set of new entry fields and contacts the game program 302. The game program 302 displays a second spinning wheel and a second set of new entry fields in process block 314. The prospect fills out and submits the second set of new entry fields to the database 308 in process block 316. The database 308 stores the information in the second set of new entry fields and contacts the game program 302.

The game program 302 displays a third spinning wheel and a third set of new entry fields in process block 318. The prospect fills out and submits the third set of new entry fields to the database 308 in process block 320. The database 308 stores the information in the third set of new entry fields and contacts the game program 302. The new entry fields preferably contain answers to survey questions. The game program 302 displays a prize and shows all three wheels ceasing rotation in process block 322. The three wheels display a sequence of icons 28. The combination of icons 28 displayed not only indicate whether a prize has been won, but what type of prize. The icons 28 and the odds of winning a particular prize may be defined by the merchant when accessing the central server 12. The merchant may program which icons will be used, the winning icon combinations, and odds of winning.

The available icons 28 preferably suit the industry, brand or product of the merchant. Preferably, the prospect will first provide basic demographic & contact information to get the first wheel to spin. Preferably answers to the user-defined customizable survey questions cause the second and third wheels to spin and completion of the survey causes the all wheels 28 to stop spinning. The prospect has a chance of winning a grand prize (ie. a million dollars, a dream home, an all expenses paid vacation). An example of user-defined customizable survey questions include “where did you hear about this retailer?”, “what type of goods are you interested in buying?” or “when do you plan on making the purchase?”

The information entry processor 10 will convert the personal contact information into an electronic file and the contact file is sent to the off-site central server 12 through the entry modem 20 and phone line 104. The off-site central server 12 will periodically send a plurality of contact files to the mail fulfillment house 14 through e-mail. The off-site central server 12 will also send an e-mail message 101 to the merchant for every prospect who enters their contact information into one of the information entry processors 10. The mail fulfillment house 14 will mail merge letters addressed to each prospect from the contact files. The letters will be dropped off at the post office 100 for mailing.

With reference to FIG. 3b, a second preferable game of chance is a computer generated flash movie 31. The flash movie 31 is a hole-in-one game. The prospect answers questions 33 displayed on the bottom of the screen and hits a next button 37 to advance to the next screen. The simulated golfer 35 will hit a golf ball which will either stop near a cup or fall into the cup. If the prospect sees the golf ball fall into the cup, they will receive some prize. If the golf ball merely stops near the cup, the prospect will not receive a prize. The operation of the second preferable game of chance is similar to that of FIG. 3.

FIG. 1a discloses a second embodiment of a method of obtaining personal and survey information 2. Access to the game of chance is obtained through a web page instead of the information entry processor 10. Entry of the personal contact information is made through a computer with internet access or some other internet access device 11. The prospect first goes to the merchant's web page. The prospect clicks on a link which allows them to play a game of chance in exchange for their personal contact information and answers to survey questions. The link connects the prospect's web access device 11 with preferably the central server 12. The central server 12 uploads a web page which may have the appearance of the merchant's web page or a default game page.

The slot machine 24 or other game of chance operates the same way as the game displayed on the information entry processor 10. The off-site central server 12 will convert the personal contact information into an electronic file. The off site central server 12 will at merchant defined intervals send a plurality of contact files to the mail fulfillment house 14. The off-site central server 12 will also send an e-mail message 101 to the merchant for every prospect who enters their contact information into one of the information entry processors 10. The mail fulfillment house 14 will generate mail merged letters addressed to each prospect from the contact files. The letters will be dropped off at the post office 100 for mailing.

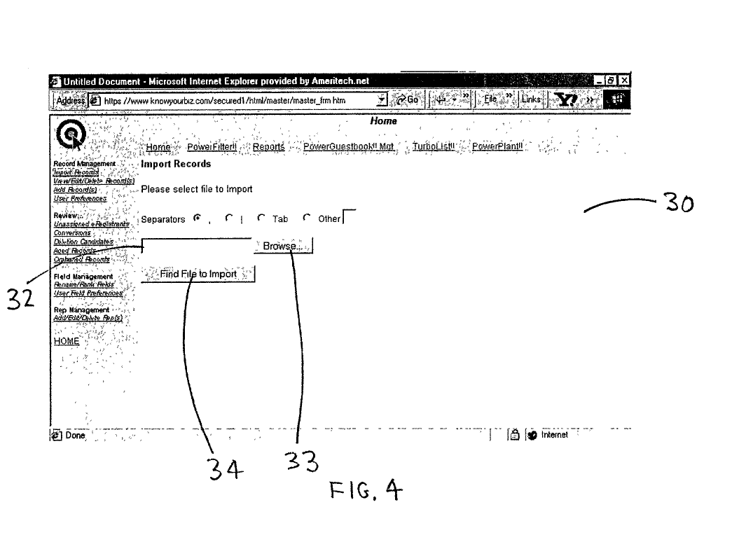

A complete list of prospects which have entered their names through the information entry processor 10 or internet access device 11 are accessible on the central server 12. Database management software located on the central server 12 allows personal information records to be manipulated by the user in numerous ways for both embodiments. With reference to FIG. 4, prospect lists from other sources may be imported into the database management software as shown in an import records screen 30. A particular prospect record or set of prospect records may be found by defining filter parameters in a browse window 32 and by depressing a browse button 33 depressed. The user may also search for the file by pressing a find file button 34.

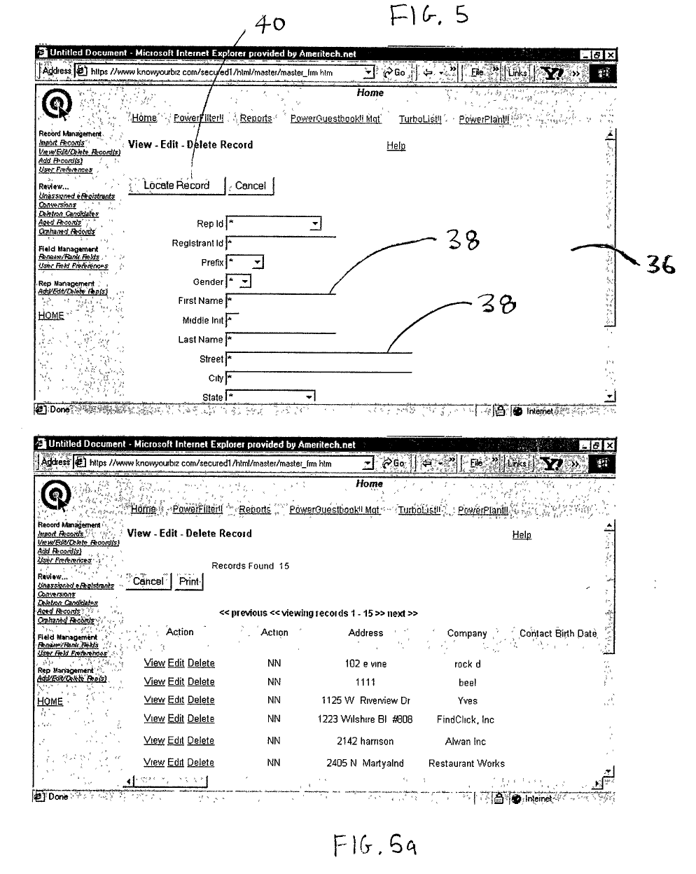

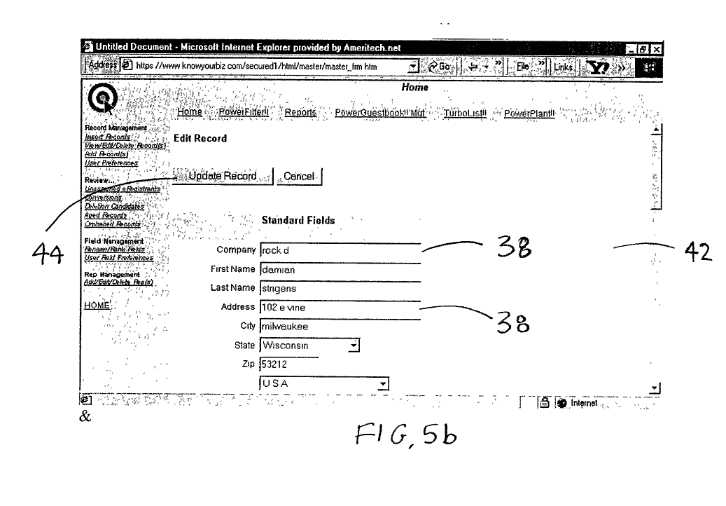

With reference to FIG. 5, personal information records may be viewed, edited, and deleted in a view-edit-delete screen 36. To find a particular record, one of the parameters such name, city, or state may be entered in one of the parameter windows 38 and a locate record button 40 depressed. After the locate record button 40 is depressed a screen displays all the records found according to data entered into the parameter windows 38 as shown in FIG. 5a. The personal record may be viewed, edited, or deleted by clicking on a link adjacent each personal record. Clicking on one of the edit links will provide an edit screen 42 shown in FIG. 5b. A personal record may be updated by changing a particular parameter window 38 and depressing the update record button 44.

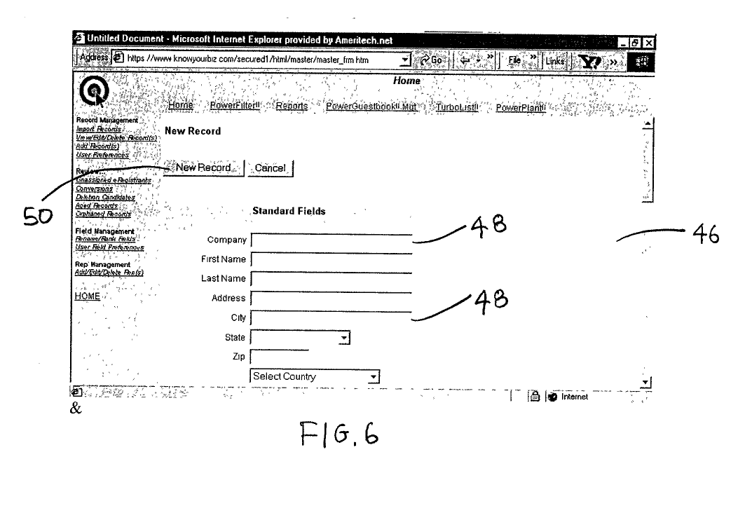

With reference to FIG. 6, new records may be manually added to the customer list through a new record screen 46. The user may create a personal record by entering data in field windows 48 and depressing a new record button 50.

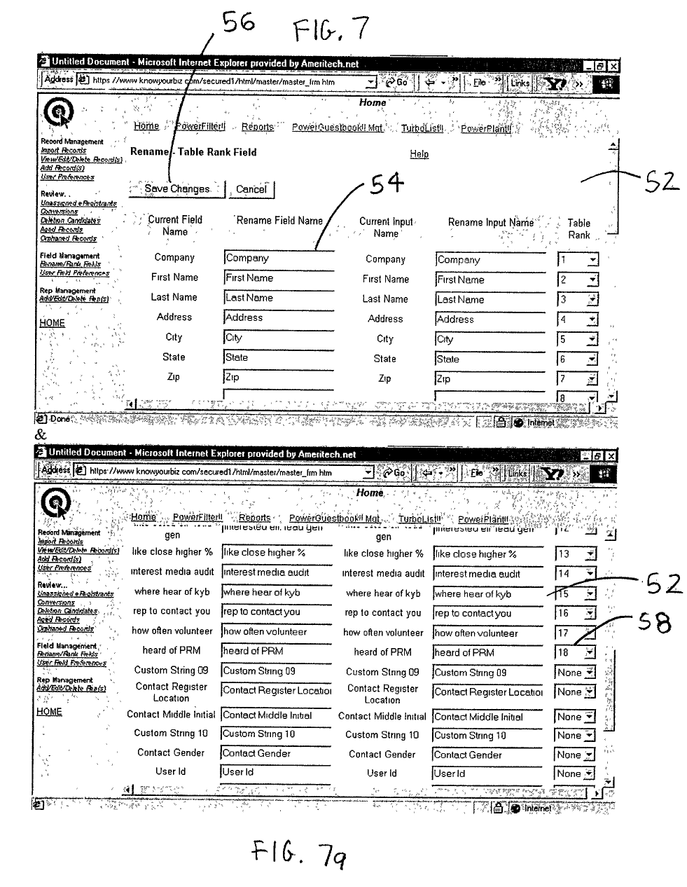

With reference to FIGS. 7 and 7a, the names and order of each field may be changed in table rank field screen 52. The field name may be changed by entering a different name in a particular field name window 54 and depressing a save changes button 56. The order of a field may be changed by entering a different number in the fields respective table rank window 58. A field may be eliminated by entering the word “none” in its respective table rank window 58. The table rank order will is defined for import and display of personal records.

With reference to FIG. 7b, the order of each field may be changed to suit a particular user in a user field preference screen 59. The order of a field may be changed by entering a different number in the field's respective user table rank window 61. The field chosen by an individual user will override the table rank defined in the table rank field screen 52. The choices of table ranks by a particular user only control the display of the table rank for that particular user.

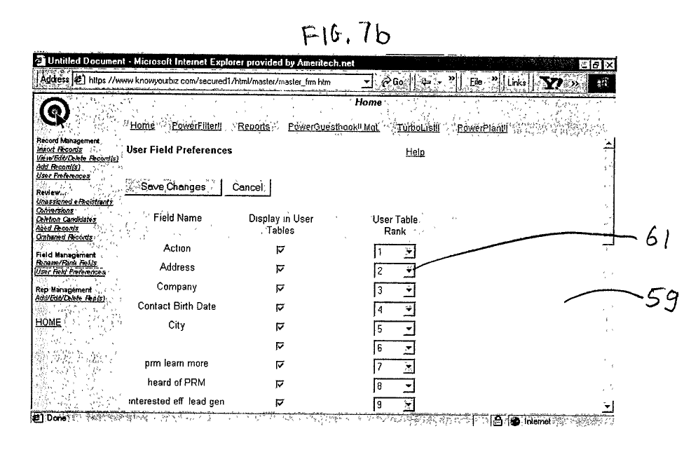

With reference to FIG. 8, personal records which are not assigned to a sales representative may be assigned a sales representative utilizing an unassigned registrant screen 60. Each personal record may be automatically assigned a representative when it is entered into the system by choosing a default sales representative. A plurality of an assigned personal records may be assigned a sales representative by highlighting one or more sales representatives in a representative window 62 and depressing an assign button 64. If more than one sales representative is chosen, personal records will be assigned in an alternating fashion. Each personal record may also be manually changed through entering data into one of the field windows 66.

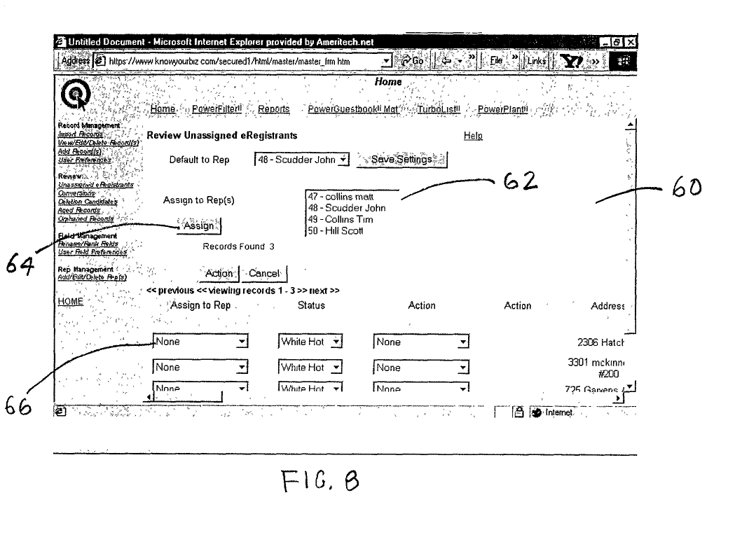

With reference to FIG. 9, the status of personal records may be changed by using a review conversion screen 68. When each personal record is received by the database management software it is assigned a white hot status. The highest status is “white hot” and the lowest status is “dormant.” The status may be changed at any time by the merchant. A search for personal records which have a particular age may be found by entering a date in reporting window 70. A search for personal record which have a particular age range may be found by enter a first date in a first date window 72 and a second date in a second date window 74. The search may be modified by choosing one or more representatives in representative window 76. The list to be searched may be chosen in source window 78.

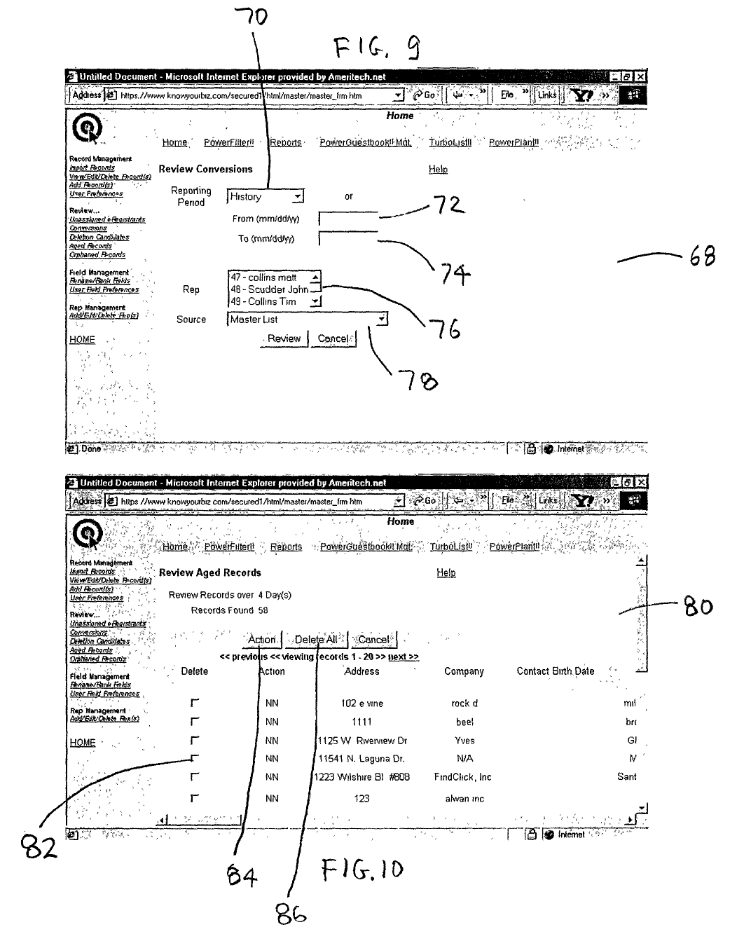

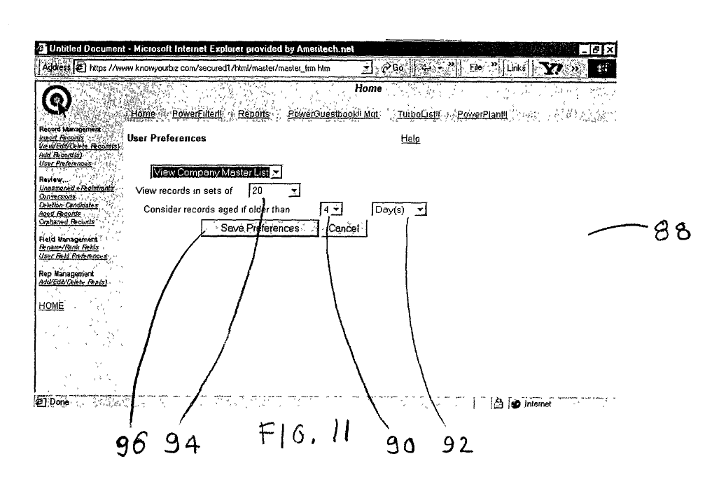

With reference to FIG. 10, the number of aged records may be found by reviewing an aged records screen 80. Individual records may be deleted by marking a delete window 82 adjacent a particular personal record and depressing an action button 84. All personal records may be deleted by pressing a delete all button 86. With reference to FIG. 11, the age of personal records to be reviewed and the number is defined in a user preference screen 88. The age is defined by setting a number in a number window 90 and a time period in a time window 92. The number of records to be displayed at a time is set in a view records window 94. The choices of age and number of records is implemented by depressing a save preferences button 96.

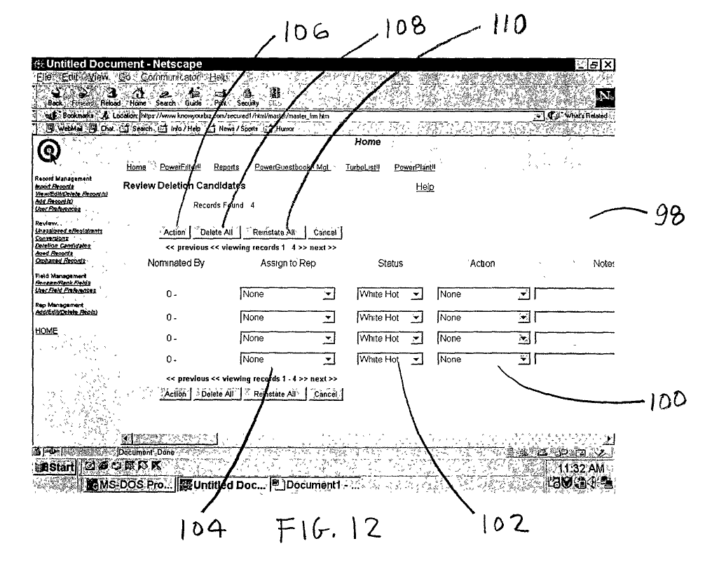

With reference to FIG. 12, personal records which have been deleted by a sales representative must be reviewed by a manager, before the personal record may be destroyed in deletion candidate screen 98. A single personal record may be deleted or reinstated by choosing the word “delete,” or “reinstate,” respectively in an action pull down window 100 and depressing an action button 102. The deletion candidate screen 98 also provides the option of changing status in a status window 102 and reassigning the personal record to a sales representative in an assign to rep window 104. A user may delete all personal records by depressing a delete all button 108 or reinstate all personal records by depressing a reinstate button 110.

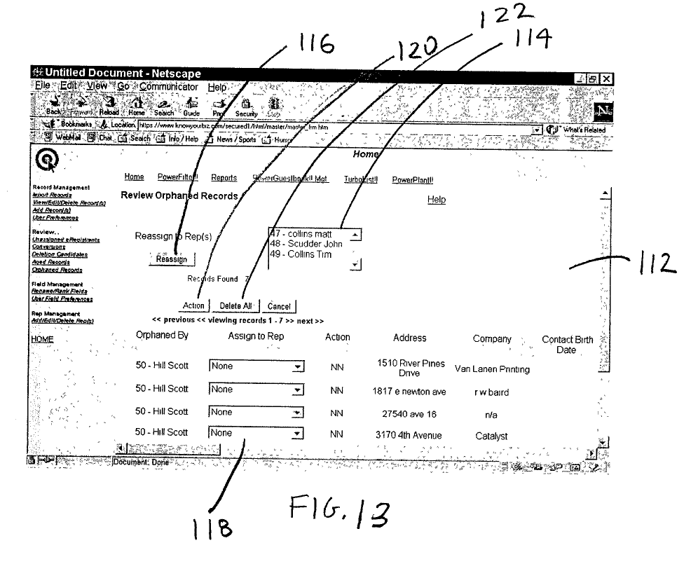

With reference to FIG. 13, when a sales representative leaves the company, their records may be reassigned to another representative in a orphaned records screen 112. A plurality of personal records may be reassigned a sales representative by highlighting one or more sales representatives in a representative window 114 and depressing an assign button 116. If more than one sales representative is chosen, personal records will be assigned in an alternating fashion. Each personal record may also be manually changed through entering data into an Assign to Rep field window 118 and depressing an action button 120. All personal records may be deleted by depressing a delete all button 122.

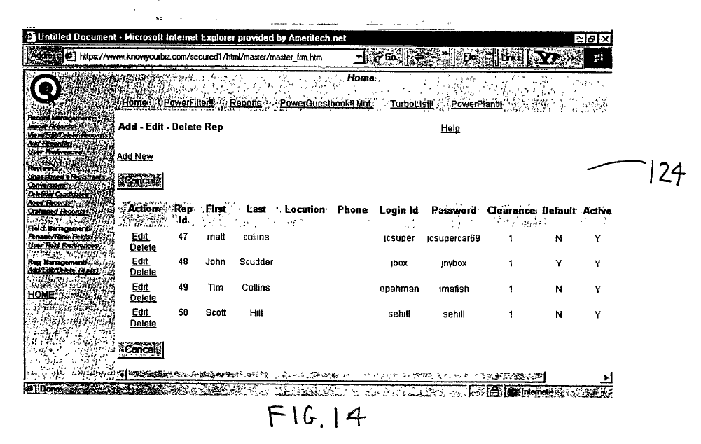

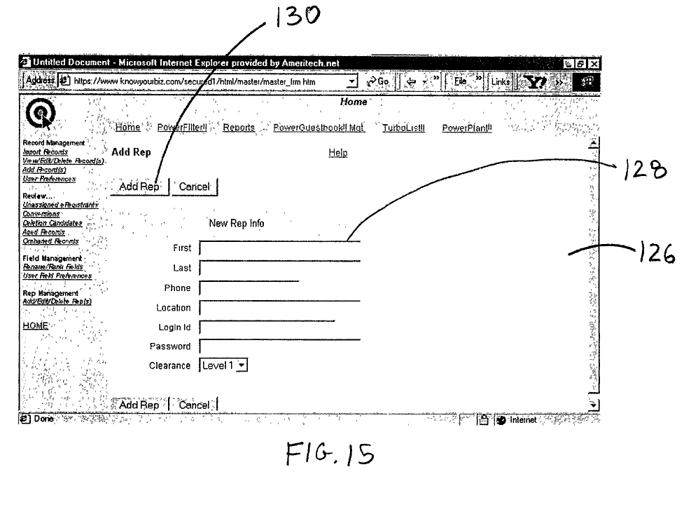

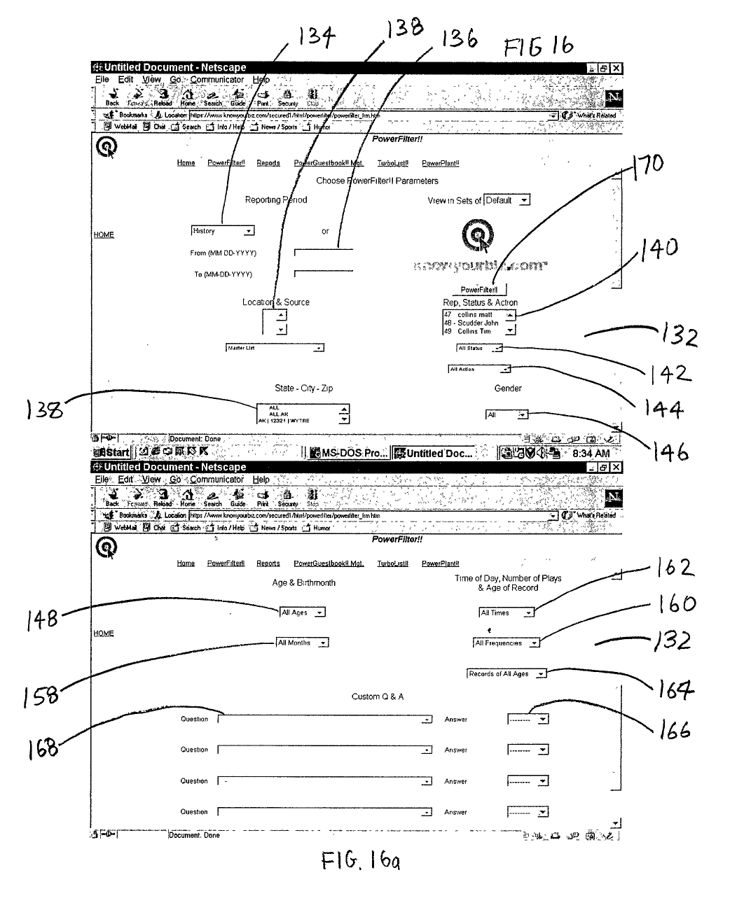

With reference to FIG. 14, sales representatives may be added, edited, or deleted in a representative screen 124. New sales representatives may be added by clicking on a “Add New” link. Clicking on the “Add New” link yields an add rep screen 126 as shown in FIG. 15. A new sales representative is added by filling in each representative window and depressing an add rep button 130. A representative may be changed or removed by clicking on a “Edit” link, or a “Delete” link.

With reference to FIGS. 16 and 16a, the plurality of personal records may be searched by different parameters such as reporting period, defined report period, sales representative, record status, action, address, gender, age, age range, month, time of day, number of entries, questions, and answers to questions in a search screen 132. A reporting period window 134 allows a present week, particular month, particular quarter, month to date, and year to date to be specified. A pair of reporting period ranges 136 allow the search to be conducted between two different dates. One or more lists of personal records may be searched in a source window 138. A search may be conducted according to a particular state, city or zip code in address window 138.

Searches may be modified by specifying one or more sales representatives in representative window 140. Status may be specified in status window 142. Action may be specified in action window 144. Gender may be specified in window 146. Age may be specified in age window 148 and the birth month in a age month window 150. Persons entering personal data more than a set number of times may be eliminated in a frequencies window 160. A search may be made modified according to the time of day that personal data was entered in a time window 162. Personal records may be found according to a particular age range in age range window 164. Personal records may be searched for a particular question and answer in question window 168 and answer window 166, respectively. After search choices have been made a powerfilter button 170 is depressed to implement the search.

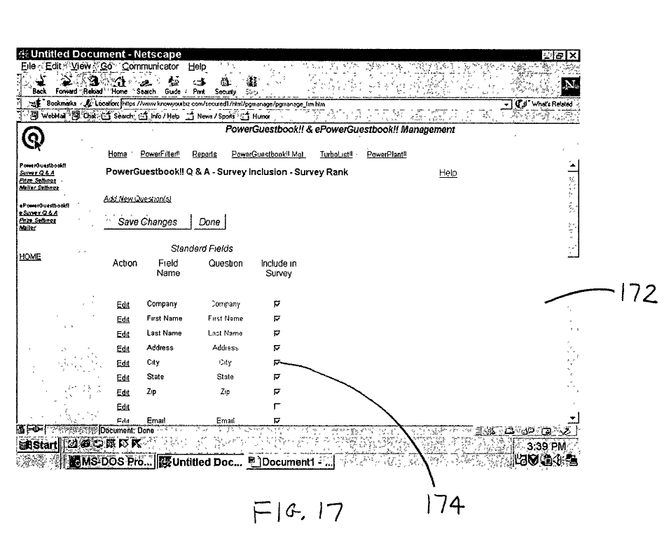

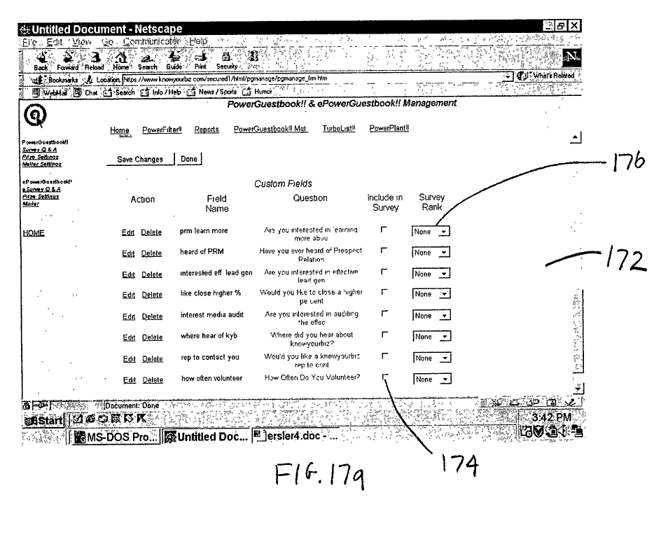

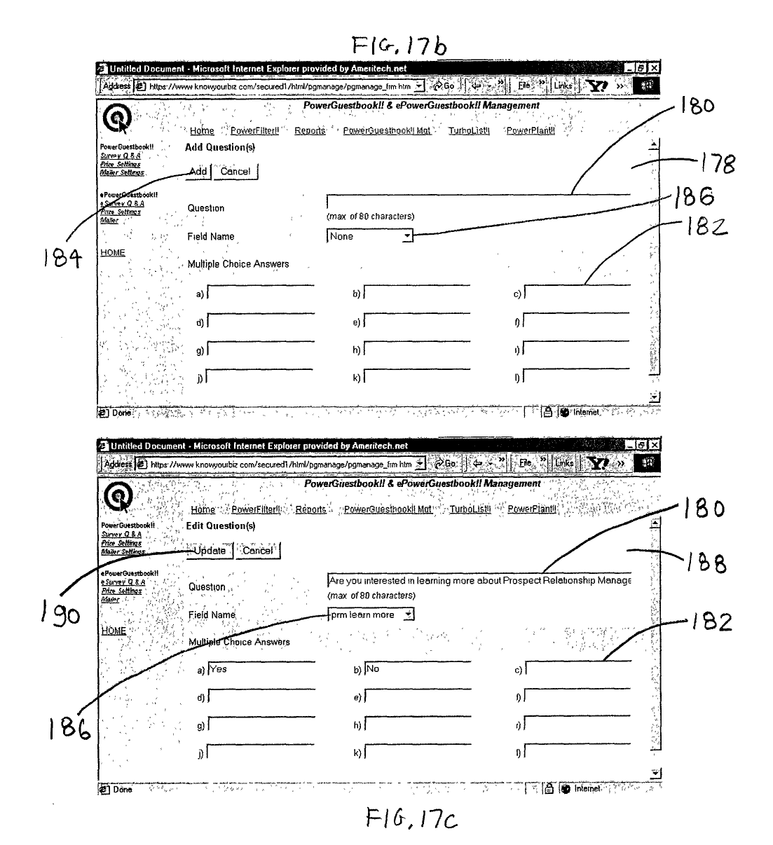

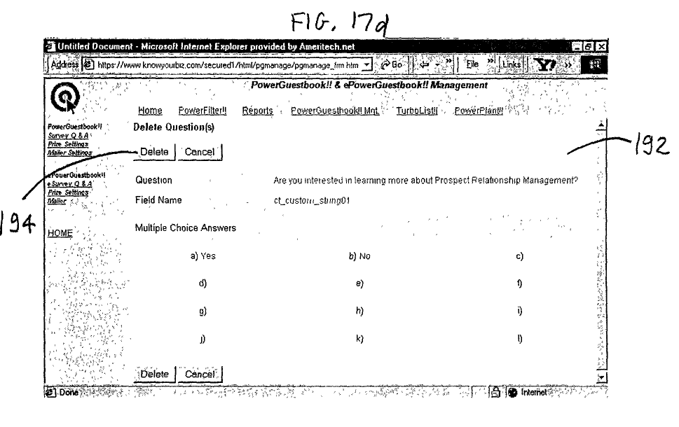

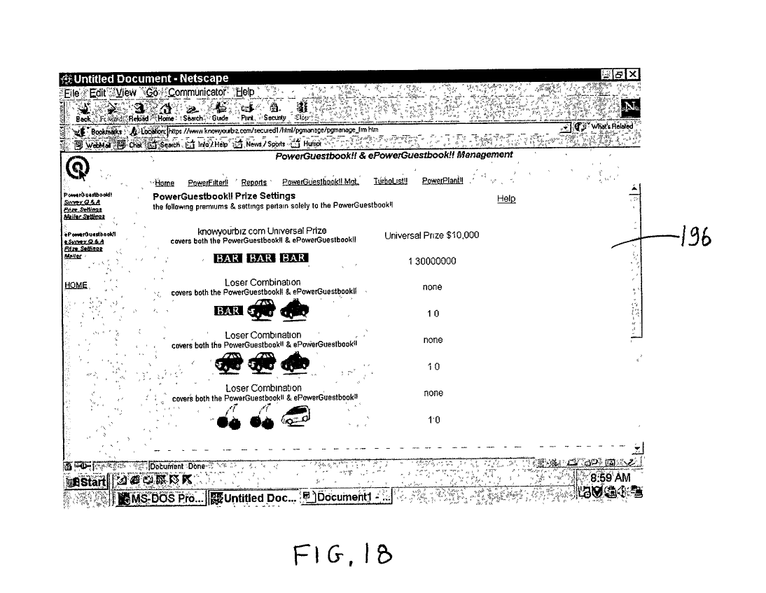

With reference to FIG. 17, questions may be created, edited, and deleted in a question screen 172. Standard questions may be chosen by marking a particular survey window 174. The field name may be modified by clicking on the Edit link. adjacent a particular question. FIG. 17a shows a bottom portion of the question screen 172 with pre-written custom questions which may be included by marking a particular survey window 174. The pre-written custom questions may be ranked according to order by entering a number in a survey rank window 176.

Clicking on an “Add New Question(s)” link at a top of the question screen 172 produces an add question screen 178 as shown in FIG. 17b. A new question may be added by writing it in an question window 180, writing answers in at least two answer windows 182 and depressing an add button 184. Each new question may be assigned a name by writing in a field name window 186. Clicking on an edit link will produce an edit question screen 188 as shown in FIG. 17c. An existing question may be changed by rewriting it in a question window 180, writing answers in at least two answer windows 182 and depressing an update button 190.

With reference to FIG. 17d, clicking on a link adjacent to a pre-written question will produce a delete question screen 192. The question and answers for the question will be displayed. The question may be deleted by depressing a delete button 194.

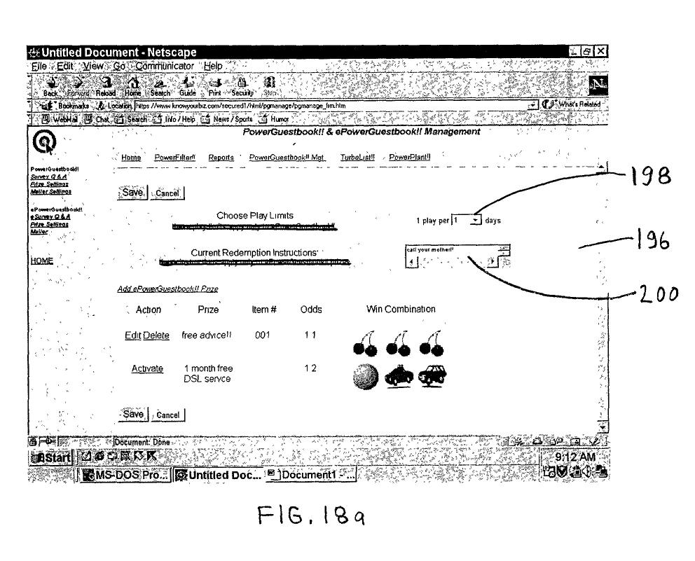

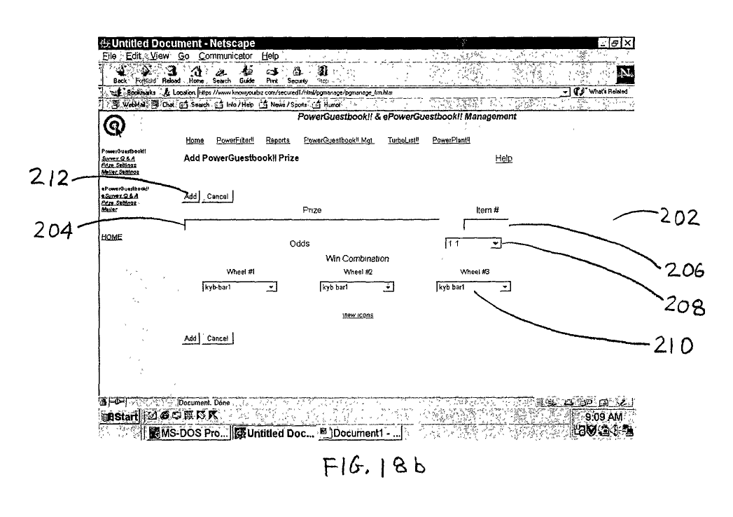

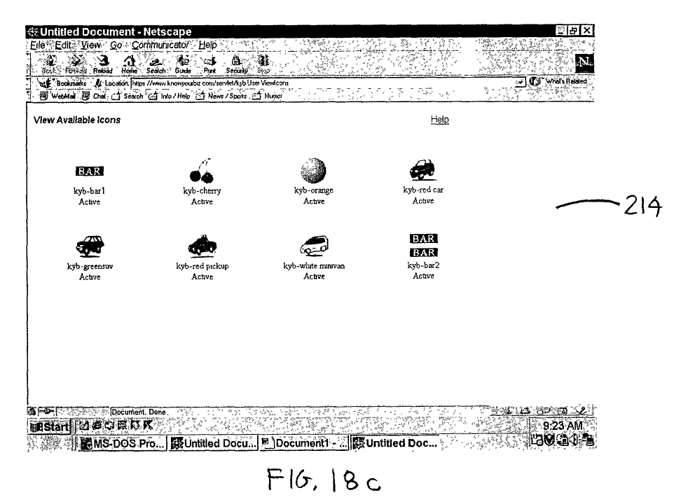

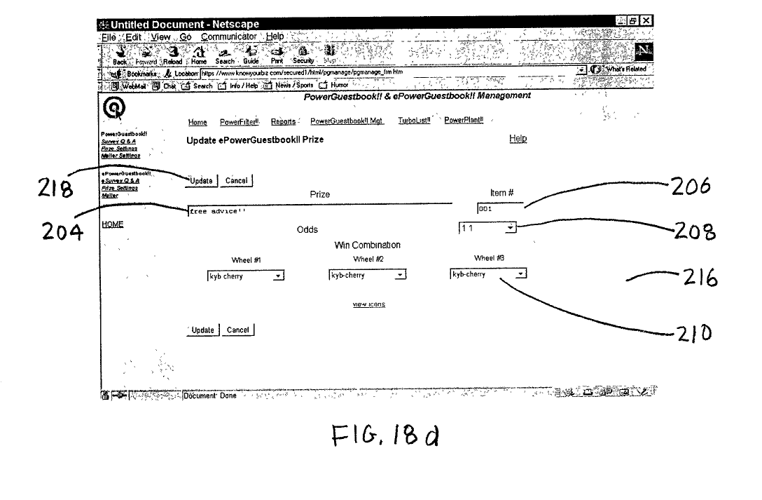

With reference to FIG. 18, prize settings may be modified in prize settings screen 196. Existing prizes and their odds are also displayed. At a bottom of the prize settings screen 196. The number of plays may be limited in play window 198. A redemption message which is displayed when any prize is won may be written in redemption window 200. Clicking on an add PowerGuestbook prize link will produce an add prize screen 202 as shown in FIG. 18b. A new prize is added by entering the name of the prize in prize window 204, the number of the prize in item window 206, the odds of winning the prize in odds window 208, a win combination by choosing an icon for each wheel window 210, and depressing an add button 212. Clicking on a view icons link will produce an icons screen 214 as shown in FIG. 18c.

With reference to FIG. 18d, parameters concerning an existing prize may be modified by clicking on an edit link adjacent the prize parameters in FIG. 18a. Clicking on the edit link produces an update prize screen 216. The update prize screen 216 allows a different prize to be entered in the prize in the prize window 204, the number of the prize may be changed in the item window 206, the odds of winning the prize may be modified in the odds window 208, and a win combination may be changed by choosing an icon for each wheel window 210. After the desired prize parameters have modified an update button 218 is depressed.

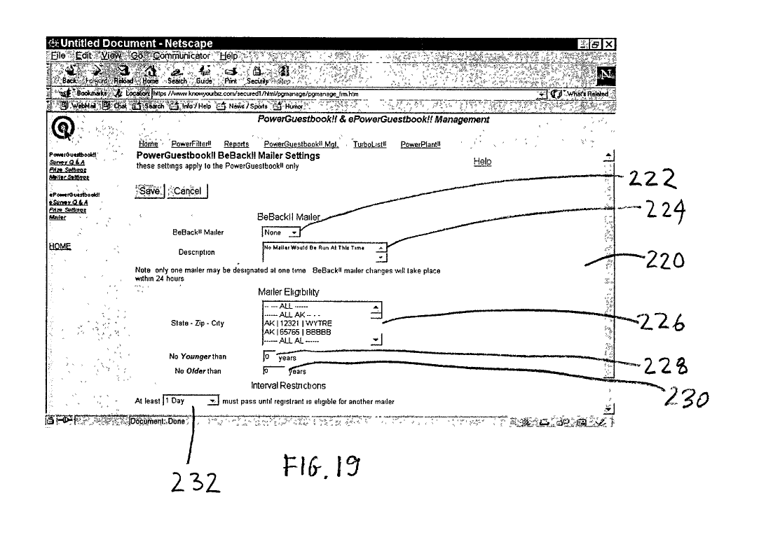

FIG. 19 discloses a mail settings screen 220 which may be utilized to modify parameters concerning follow-up mailings for the first embodiment. The type of mailing may be chosen in a mailer window 222. One or more mailing devices may be chosen by highlighting a description window 224. The location of where mailing is sent may be specified in an address window 226. An age range of mailing recipients may be set in low age window 228 and high age window 230. A registrant may not receive a further mailing until the time entered in time window 232 passes.

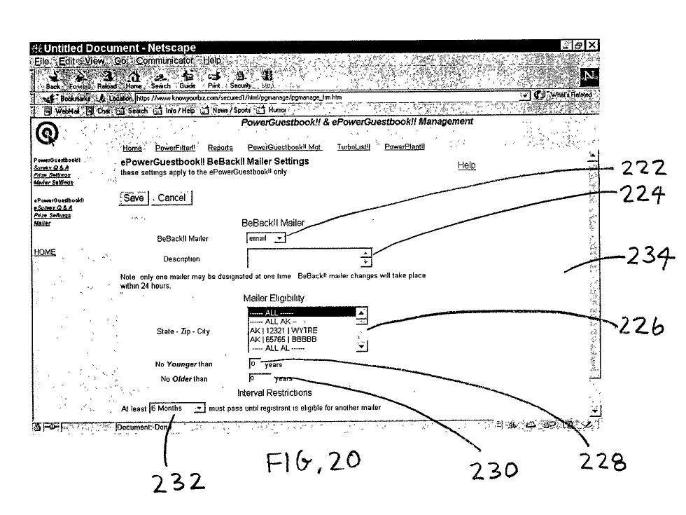

FIG. 20 discloses a mail settings screen 234 which may be utilized to modify parameters concerning follow-up mailings for the second embodiment. The type of mailing may be chosen in a mailer window 222. With the second embodiment, the mailing is preferably an e-mail. One or more mailing devices may be chosen by highlighting a description window 224. The location of where mailing is sent may be specified in an address window 226. An age range of mailing recipients may be set in low age window 228 and high age window 230. A registrant may not receive a further mailing until the time entered in time window 232 passes.

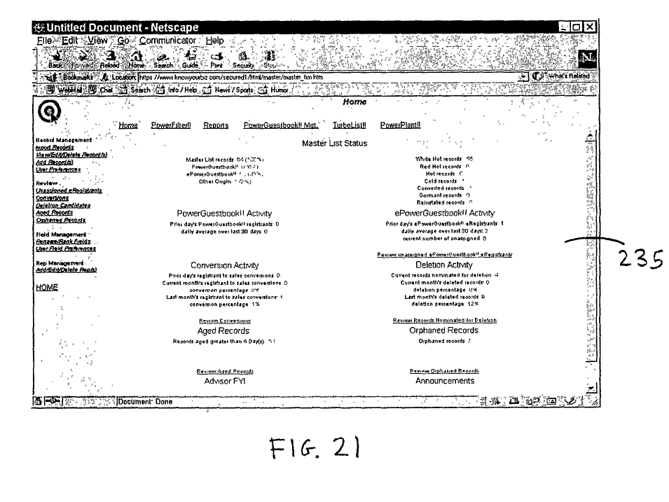

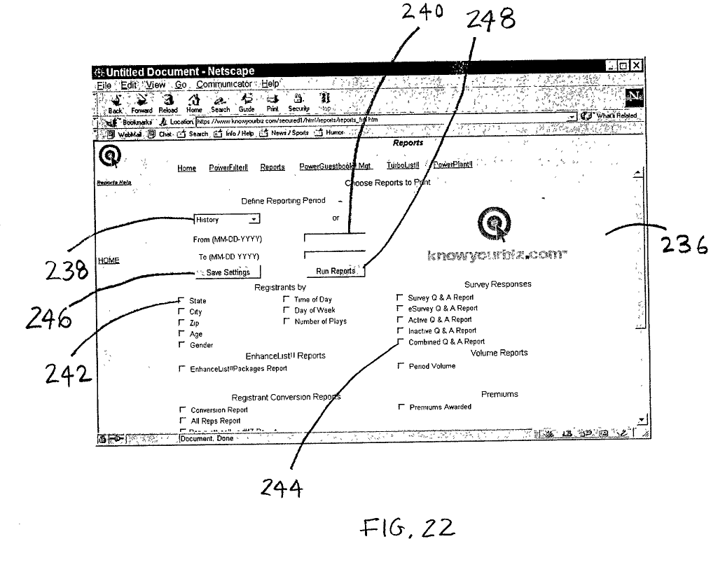

With reference to FIG. 21, a master list status screen 235 displays various data concerning personal records. FIG. 22 discloses a print screen 236 which allows reports to be printed according to different selectable parameters. A reporting period window 238 allows a present week, particular month, particular quarter, month to date, and year to date to be specified. A pair of reporting period ranges 240 allow the search to be conducted between two different dates. Reports may be printed according to different parameters under a “Registrants” title by marking a parameter window 242. Reports may also be printed according to specific set questions by marking a Q & A parameter window 24 under a “Survey Responses” title. An unique set of parameter choices may be saved by depressing a save settings button 246. Reports are printed by depressing a run reports button 248.

Multiple levels of security access for accessing any of the previously identified screens. The lowest level of security is the representative level. The representative is only allowed to access their own personal records and no other representative. The next higher level of security is the manager access level. The manager is allowed to access the personal records of all their representatives. The highest level of security is the general manger level. The general manager may view any personal record from any representative or manager. The general manager has access to functions of the database management tool which others on the two lower levels do not, such as defining odds, defining prizes, add/edit/deleting representatives, editing ranking fields, changing mailer settings, and deleting records.

The customer list is updated as often as requested to ensure that the addresses on the customer list are correct. The updating may be implemented by sending the list of prospects electronically to the United States Post Office National Change of Address Department, which has the most complete list of up to date mailing addresses. The USPS National Change of Address Department sends back the file with all possible address updates.

The customer may also be enhanced by sending thereof to a list company which goes to various data base sources such as the department of motor vehicles or mortgage companies to obtain more information about the prospect. The prospect list is then sent back to the user with the additional, enhanced demographic information about the prospect. The enhanced customer list may be used to create a profile of the type prospect which should be sent direct mail. The profile of the prospect which is a candidate for direct mail is sent to a list company. The list company provides a list of new prospects based upon region of interest & the profile developed from the enhanced customer list.

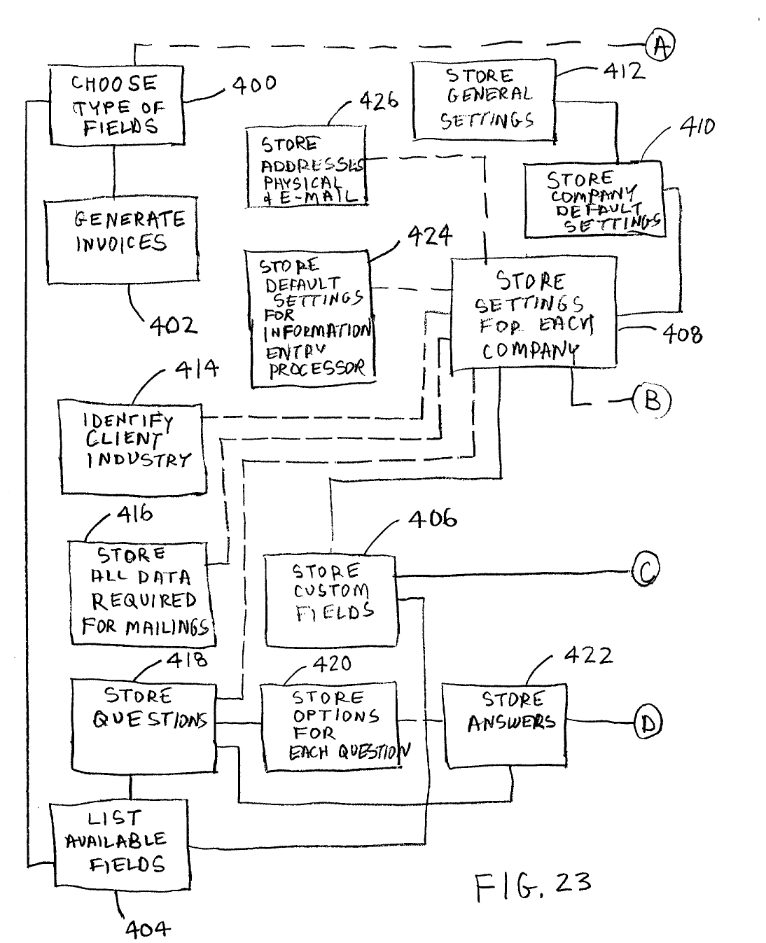

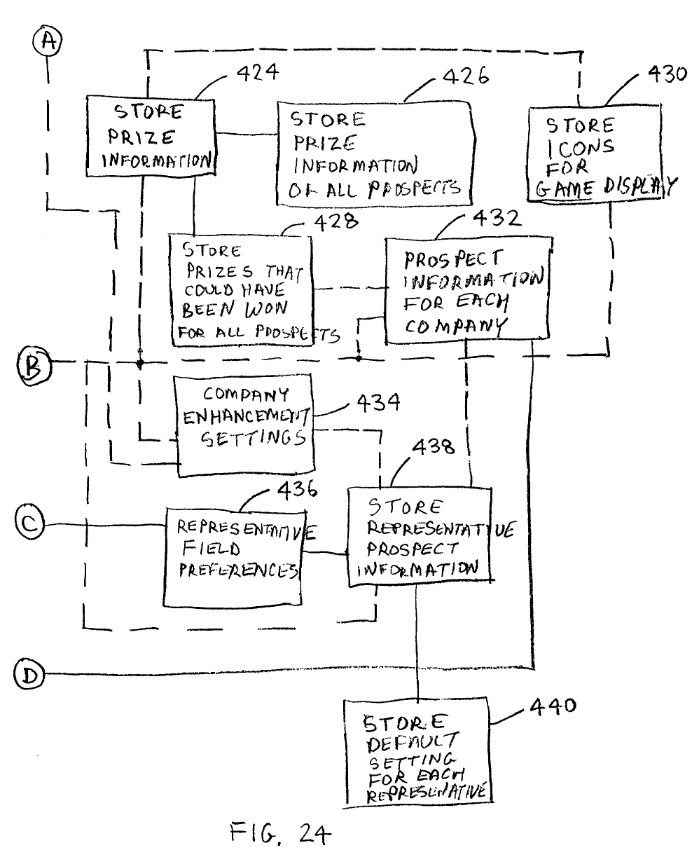

FIGS. 23 and 24 show a relational flow chart of the database management software program. The feature blocks are interconnected with solid and/or dotted lines. The solid lines denote direct relationships and dotted line denote contributory or non-direct relationships. Types of fields are defined and the way the fields should be treated are stored in feature block 400. Invoices for a given company are stored in feature block 402. Feature block 404 identifies and lists fields available for anyone to use in a contact table. The fields are standard, custom, and enhanced. Custom fields which are chosen and purchased by a particular company are stored in feature block 406. The settings for each company are stored in feature block 408. Each company has their own sets of fields which are defined, stored and treated differently.

Each company has different default settings which are stored in feature block 410. General settings for each company are stored in feature block 412. The general settings are used to control different functionality of the software such as e-mail addresses for new contact notifications. The industry of a particular company is stored in feature block 414. Mail settings for each company, the type of mailers to be sent, and the parameters of the mailer are stored in feature block 416. Specific questions which a particular company may ask a prospect are stored in feature block 418. Each option to each question is stored in feature block 420. The answers to all questions are stored in feature block 422.

The probability of winning a particular prize along with the prize's gif is stored in feature block 424. Information concerning each prospect is stored with their winning prize combinations in feature block 426. Feature block 428 stores all details for each prize that could have been won by a particular prospect. The gifs for a particular company and the gifs for each prize are stored in feature block 430. Each companies' prospects and the information of each prospect is stored in feature block 432. Additional information about certain prospects are stored in feature block 434. Feature block 436 stores details of fields; namely, the name of the field, and its order relative to other fields. Feature block 438 stores representatives, the prospects assigned to each representative, settings unique to each representative, and the level of access of each representative. The default settings of each representative is stored in feature block 440.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A method of obtaining information from a prospect comprising the steps of:
a) providing an information entry processor;
b) offering a prize in exchange for the entry of information about the prospect into said information entry processor;
c) sending said information to a central server; and
d) sending the prospect a reply to said entry of personal information.

2. The method of obtaining personal information from a prospect of claim 1, wherein:
said reply being a letter sent through the postal service.

3. The method of obtaining personal information from a prospect of claim 1, wherein:
said reply being an e-mail message.

4. The method of obtaining personal information from a prospect of claim 1, wherein:
said information being personal contact information.

5. The method of obtaining personal information from a prospect of claim 1, wherein:
said information being answers to a set of survey questions.

6. The method of obtaining personal information from a prospect of claim 5, wherein:
said survey questions being customizable by a party asking said survey questions.

7. The method of obtaining personal information from a prospect of claim 1, wherein:
said information entry processor including an internet access device connected to an internet web page, said internet web page sending said personal information to said central server.

8. The method of obtaining personal information from a prospect of claim 1, wherein:
database management software enabling a party to manipulate various different parameters describing each prospect and the time when the prospect made their entry of information.

9. The method of obtaining personal information from a prospect of claim 1, wherein:
database management software enabling a party to edit questions asked of the prospect.

10. A system for obtaining information from a prospect comprising:
at least one information entry processor facilitating the entry of information, said information being converted into an electronic file;
a central server receiving at least one electronic file from said at least one information entry processor, said central server entering each said electronic file into a database; and
a mail fulfillment house receiving a plurality of electronic files from said central server, said mail fulfillment house mailing a reply letter to each person listed in said plurality of electronic files.

11. The system for obtaining information from a prospect of claim 10, further comprising:
database management software enabling a party to manipulate various different parameters describing each prospect and the time when the prospect made their data entry.

12. The system for obtaining information from a prospect of claim 10, further comprising:
database management software enabling a party to edit questions asked of the prospect.

13. A system for obtaining personal contact information from a prospect comprising:
at least one internet access device facilitating the entry of information, said information being converted into an electronic file;
an internet web page being connected to said at least one internet access device; and
a central server receiving at least one said electronic file from said internet web page, said central server entering each said electronic file into a database, said central server sending a reply to each person listed in said plurality of electronic files.

14. The system for obtaining personal contact information from a prospect of claim 13, further comprising:
said reply being a letter sent through the postal service.

15. The system for obtaining personal contact information from a prospect of claim 13, further comprising:
said reply being an e-mail message.

16. The system for obtaining personal contact information from a prospect of claim 13, further comprising:
database management software enabling a user to manipulate various different parameters describing each prospect and the time when the prospect made their data entry.

17. The system for obtaining personal contact information from a prospect of claim 13, further comprising:
database management software enabling a party to edit questions asked of the prospect.
